(19) United States
(12) Patent Application Publication
(10) Pub. No.: US 2006/0031369 A1
(43) Pub. Date: Feb. 9, 2006

(54) Method, system, and edge multimedia messaging service (MMS) relay/server for multi-staged MMS

(76) Inventors: Marc Caron, Laval (CA); Per Andersson, Montreal (CA); Andre Beliveau, Laval (CA); Peter Helfer, Montreal (CA); Bernhard Meier, St. Lazare (CA)

Correspondence Address: Alex Nicolaescu;Ericsson Canada Inc., Patent Department, 8400 Decarie Blvd., Town Mount Royal, QC, H4P 2N2, CA

(21) Appl. No.: 10/880,473

(22) Filed: Jul. 1, 2004

(51) Int. Cl. G06F 15/16

(52) U.S. Cl. 709/207

(57) ABSTRACT

A method, system and Edge Multimedia Messaging Service (MMS) Relay/Server for handling MMS messages in an MMS system, wherein incoming MMS messages are received at the Edge MMS Relay/Server from User Agents (UAs). The former determines criteria associated with the MMS messages and based on the criteria, selectively forwards the MMS messages to the proper MMS Relay/Server of a second stage of the MMS system, where the MMS messages are handled based on their type, and further delivered to the MMS recipients. Such criteria may include the retrieval time of the messages, the type of subscription of the user (prepaid vs postpaid), the need for transcoding the MMS message, and immediate vs future delivery time.

### BACKGROUND OF THE INVENTION

1. Field of the Invention

The present invention relates to Multimedia Messaging Service (MMS).

2. Description of the Related Art

Multimedia Messaging Service (MMS), sometimes also called multimedia messaging system, is a communications technology developed by the Third Generation Partnership Project (3GPP) that allows users to exchange multimedia communications between capable mobile phones and other devices. An extension to the Short Message Service (SMS) protocol, MMS defines a way to send and receive wireless messages that include images, audio, and video clips in addition to text. MMS may also support the transmission of streaming video. A common current application of MMS messaging is picture messaging, i.e. the use of camera phones to take photos for instant delivery to a mobile recipient. Other possibilities of MMS transmissions include animations and graphic presentations of stock quotes, sports news, and weather reports.

MMS may be developed in two separate phases. Based on the General Packet Radio Services (GPRS), the currently available MMS is somehow similar to a brief PowerPoint™ presentation. The second phase of MMS may require a Third Generation (3G) network to further enable streaming video.

FIG. 1 (Prior Art) shows a typical MMS network implementation. Shown in FIG. 1 is a first service provider network “X” 100 and a second service provider network “Y” 102, which may be connected via an MM4 interface 103, as defined in the 3GPP Technical Specification (3GPP TS) 23.140 and which is herein included by reference, is a reference point between MMS Relay/Servers belonging to different MMSEs (MMS Environments, i.e. service providers). The interworking between MMSEs is typically based on the Simple Mail Transfer Protocol (SMTP) protocol defined in the Internet Engineering Task Force (IETF) Request for Comments (RFC) 2821, which is also herein included by reference. The MM4 interface is used to transfer MMS messages and associated communications (delivery reports, read reports) between MMSEs. Shown connected to the network 100 are two MMS User Agents (UAs) “A” 104 and “B”106 that may be comprised within mobile terminals. Likewise, shown connected to the network 102 is UA “C” 112, which may also be comprised in a mobile terminal. It is to be noted that many more UAs may be connected to each one of the networks “X” 100 and “Y” 102, although they are not illustrated in FIG. 1 for simplicity purposes. Each of the networks “X” 100 and “Y” 102 comprise a respective MMS Relay/Server 108 and 110, which function is to receive, process, store, and further distribute MMS messages to and from their respective users. For example, the MMS Relay/Server 108 is responsible for receiving, processing, storing and distributing MMS messages received or destined to UAs “A” 104 and “B” 106, while the MMS Relay/Server 110 is responsible for receiving, processing, storing, and distributing MMS messages received or destined to UA “C” 112.

In a typical MMS transmission scenario, a first MMS UA (e.g. the UA “B” 106) sends an MMS message 120 to a second MMS UA (e.g. to the UA “A” 104), using a Hyper Text Transfer Protocol (HTTP) POST command. The MMS message 120 then reaches the MMS Relay/Server 108, which first detects if the message recipient, i.e. the UA “A” 104, is registered with the network 100 and if so, stores the MMS message 120. The MMS Relay/Server 108 further sends an SMS notification 122 to the UA “A” 104 in order to notify of the existence of the MMS message to be retrieved from the MMS Relay/Server 108. Responsive to the SMS notification 122, the UA “A” 104 issues an HTTP GET message 124 towards the MMS Relay/Server 108 requesting the retrieval of the MMS message, which is performed in action 126.

Analogously, if the recipient of the MMS message is not registered with the network “X” 100, but rather resides within another network, like the UA “C” 112 in the network “Y” 102, an analogous MMS transmission scenario takes place. In this scenario, the MMS message 120 is forwarded by the MMS Relay/Server 108 to the MMS Relay/Server 110, where it is stored, and messages 122-126 are rather exchanged between the MMS Relay/Server 110 and the UA 112 for the notification and the retrieval of the MMS message.

In the typical prior art scenarios for MMS messages transmission, there is always one MMS Relay/Server that takes care of the exclusive receiving and distribution of the MMS messages within a given network, as shown in FIG. 1.

FIG. 2 shows a high-level network diagram illustrative of the prior art implementations. In FIG. 2, it is shown that for each one of the networks “A” 200 and “B” 202 there is one MMS Relay/Server, such as the MMS Relay/Servers 204 and 206 respectively, which is responsible for the treatment of the MMS messages within that network.

Another possible implementation known in the prior art is illustrated in FIG. 3, which shows two service servers 300, and 302 (within the same network) that perform the same service for the same group of terminals 304 in a load-balancing configuration. Servers 300 and 302 may be, for example, email servers, which provide email service to terminals 304. In FIG. 3, a load balancing interface 306 selectively transmits requests and messages originated by the terminals 304 to one or the other of the servers 300 and 302 in order to balance the processing load of the servers.

To summarize, in most prior art implementations, there is only one MMS Server that is assigned exclusive responsibility for processing MMS messages within a given network, and therefore the resources of such server may rapidly become overloaded in peak traffic situations. In addition, using only one MMS Server within an entire network for providing a given service creates difficulty in gradually dimensioning the resources of the server in order to cope with the natural increase of the traffic over a long period of time is (e.g. coping with subscriber increase). A large centralized MMS Server is also subject to lead to MMS service failure when it goes out-of-service.

It would be advantageous to have a more scalable approach, wherein MMS Relay/Servers could be dedicated to specific processing of messages that would enable more flexibility for coping with the traffic variations.

None of the prior art implementations makes use of the nature of the message originator and/or recipient's subscriptions, or of the content of the message, for determining the most appropriate node for treatment of such MMS message.

Although there is no prior art solution as the one proposed hereinafter for solving the above-mentioned deficiencies, the publication “Intelligent SMS Routing, General Product Description”, by Telsis Co., published in July 2003 (hereinafter called Telsis), bears some relation with the field of the present invention. Telsis teaches an SMS router comprising a feature called SMS Direct Delivery. According to this feature, the SMS router intercepts all SMS messages of a network, and instead of forwarding the messages to the SMS Center, or to store-and-forward them, it delivers the SMS messages directly to the destination. The messages that cannot be directly delivered to the recipients are sent to the unique SMS Center for store-and-forward processing. However, in Telsis, the router attempts to perform the same treatment to all SMS messages, i.e. to directly transmit all SMS messages to the recipients, and does not distinguish between the nature of such messages. Furthermore, unlike the MMS, SMS is not a store-and-forward technology. In SMS, messages can be sent directly to the recipient without the later actively requesting the retrieval of the message like in MMS. Therefore, the concept described by Telsis cannot be applied to MMS.

Accordingly, it should be readily appreciated that in order to overcome the deficiencies and shortcomings of the existing solutions, it would be advantageous to have a method and system for effectively processing MMS messages in a network having a plurality of MMS Relay/Servers, each destined to a given type of MMS messages. Furthermore, it would be even more advantageous to have an MMS architecture that allows handling the MMS messages lifecycle through multistage processing, which enhances the network scalability and ability to process higher throughput of messages. The present invention provides such a solution.

### SUMMARY OF THE INVENTION

In one aspect, the present invention is a method for handling a Multimedia Messaging Service (MMS) message in an MMS system, the method comprising the steps of:

a. receiving an incoming MMS message at an Edge MMS Relay/Server of the MMS system;

b. determining in the Edge MMS Relay/Server one or more criteria related to the incoming MMS message; and

c. responsive to the determination of the one or more criteria related to the MMS message, forwarding the MMS message from the Edge MMS Relay/Server to another MMS Relay/Server of a second stage of the MMS system;

wherein the other MMS Relay/Server is connected to the Edge MMS Relay/Server and is responsible for handling MMS messages that satisfy the one or more criteria.

In another aspect, the present invention is an Edge MMS Relay/Server for use in an MMS system, the Edge MMS Relay/Server comprising:

service logic acting to determine one or more criteria related to an incoming MMS message, and responsive to the determination of the one or more criteria, further acting to forward the MMS message from the Edge MMS Relay/Server to another MMS Relay/Server of a second stage of the MMS system;

wherein the Edge MMS Relay/Server is connected to the other MMS Relay/Server which is responsible for handling MMS messages that satisfy the one or more criteria.

In another aspect, the present invention is an MMS system comprising:

a first stage of MMS Relay/Servers containing an Edge MMS Relay/Server receiving incoming MMS messages from MMS User Agents (UAs); and

a second stage of MMS Relay/Servers containing a plurality of MMS Relay/Servers, each MMS Relay/Server from the plurality of MMS Relay/Servers being dedicated to the handling of a certain type of MMS messages;

wherein the Edge MMS Relay/Server determines one or more criteria related to an incoming MMS message, and responsive to the determination of the one or more criteria related to the MMS message, forwards the MMS message to one MMS Relay/Server of the plurality of MMS Relay/Servers.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is a high-level network diagram of a typical MMS network implementation;

FIG. 2 (Prior Art) is another high-level network diagram illustrative of the typical MMS implementation;

FIG. 3 (Prior Art) is a high-level network diagram of another possible implementation known in the art;

FIG. 4 is an exemplary high-level network diagram representative of the preferred embodiment of the invention; and

FIG. 5 is an exemplary high-level flowchart diagram of a method according to the preferred embodiment of the invention.

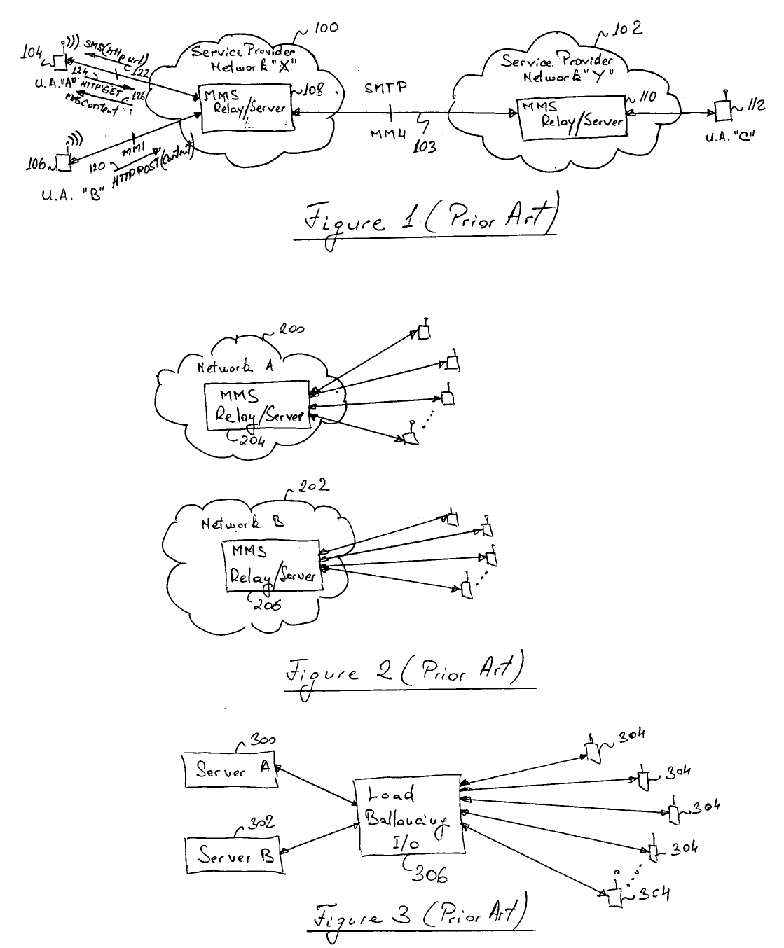

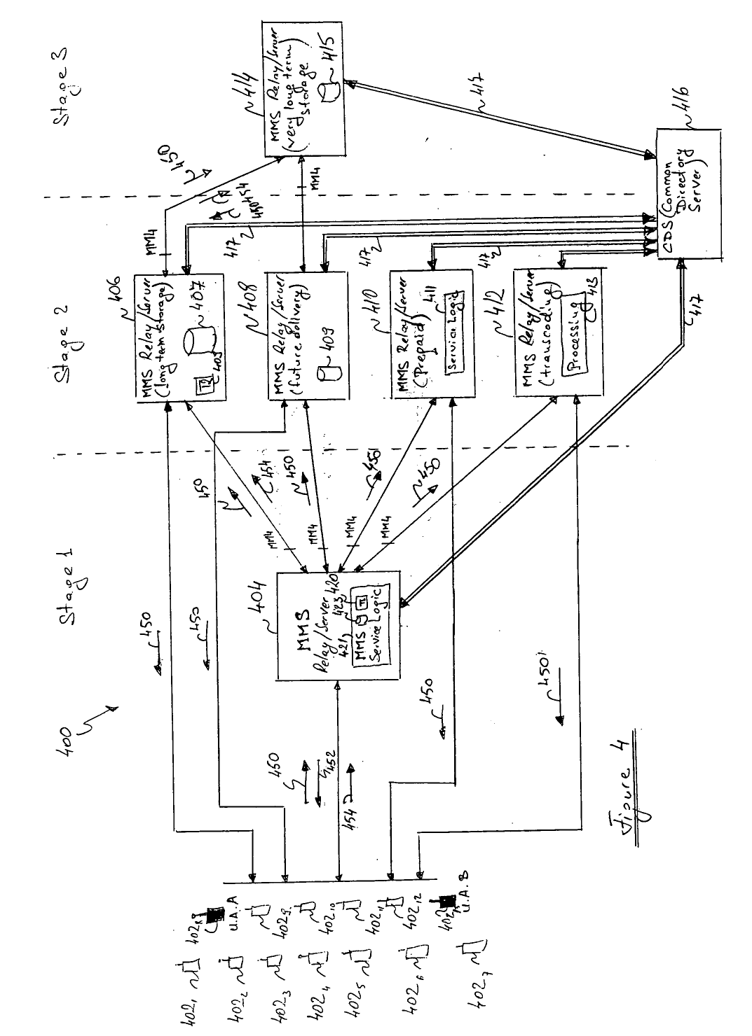

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention resolves the before mentioned deficiencies by providing for a solution where the Multimedia Messaging Service (MMS) Relay/Server functionality of an MMS system is spread over an internal network of MMS Relay/Servers that communicate between each other using an interface, such as for example the MM4 interface. The different MMS Relay/Servers of the present invention are each assigned a different function for supporting one or more MMS-related features. This tiered or staged architecture enables an intelligent routing of MMS messages over the MM4 interface within an operator's network as it also enables the efficient usage of resources of each MMS Relay/Server. Unlike in the prior art MMS systems, wherein only one MMS Relay/Server was provided for handling MMS traffic within a network, the present invention proposes a multi-stage MMS architecture in which multiple MMS servers are “serially” configured to handle the MMS traffic.

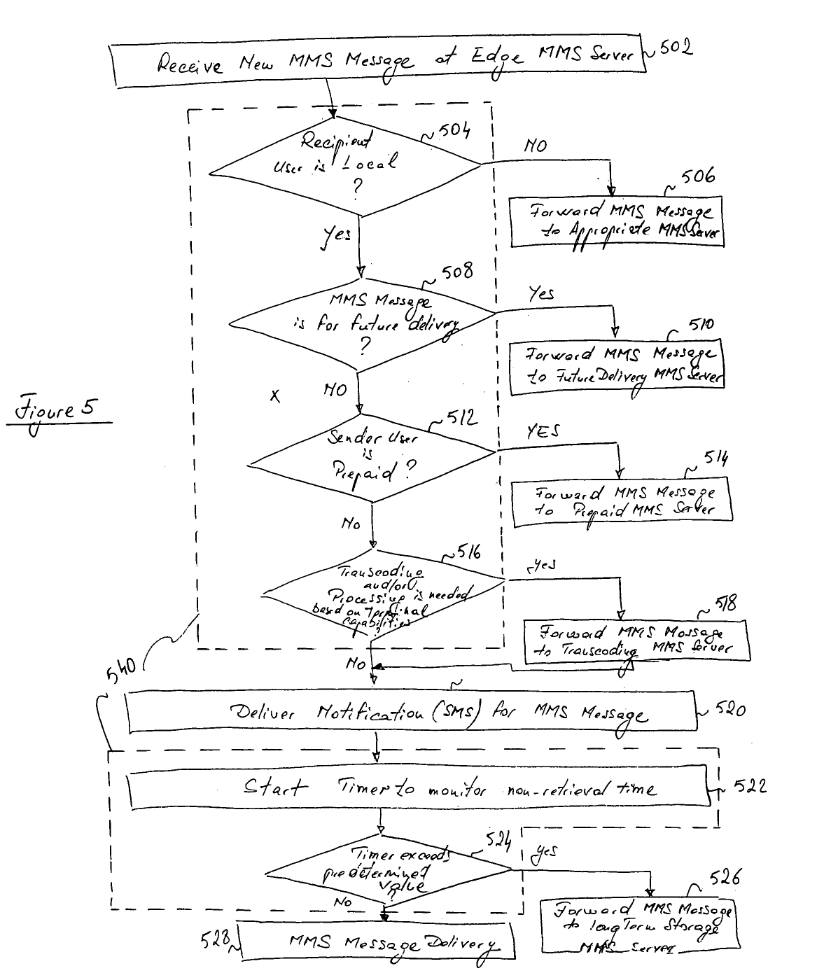

Reference is now made to FIG. 4, which is an exemplary high-level network diagram representative of the preferred embodiment of the invention. Shown in FIG. 4 are first, a plurality of MMS User Agents (UAs) 402ᵢ that may be comprised within respective mobile stations, and which are capable of sending and receiving MMS messages. In FIG. 4, the functionality of an MMS Relay/Server is spread among multiple stages (stages 1, 2, and 3) of MMS Relay/Servers, which may be linked among each other via MM4 interfaces, as shown. For example, a first stage of the functionality may comprise an MMS Relay/Server 404, which is also herein called the edge MMS Relay/Server since it resides at the edge between the core MMS network and the MMS UAs 402ᵢ, where it insures the interface with the served UAs. A second stage of MMS Relay/Servers may include multiple servers, each one being assigned the function of treating particular types of MMS messages, or MMS messages that satisfy certain criteria. For example, the MMS Relay/Server 406 may be assigned the function of handling MMS messages that are stored by the network's MMS functionality for a period of time exceeding a predetermined duration, such as for example five minutes. Such circumstances may arise when the recipient of such an MMS message fails to retrieve the message from the MMS system 400 within the predefined period of time. The second stage of MMS Relay/Servers may further comprise an MMS Relay/Server 408 responsible for handling MMS messages that have future delivery times set by the originator, an MMS Relay/Server 410 responsible for treating MMS messages related to prepaid subscribers, and an MMS Relay/Server 412 for treating MMS messages that necessitate transcoding or other kind of message processing based on the capabilities of the recipient subscriber's terminal. It is understood that other types of MMS Relay/Servers may exist as well.

Finally, also shown in FIG. 4 is a third stage of MMS Relay/Servers that may contain the MMS Relay/Server 414, which function may be, for example, to store MMS messages that are not retrieved by subscribers for a very long period of time, such as for example one week. All MMS Relay/Servers 404-414 are linked to a Common Directory Server (CDS) 416 via connections 417 shown in double lines using a protocol such as LDAP (Lightweight Directory Access Protocol), which is defined in IETF's RFC 2251, also herein included by reference. The function of the CDS is to store subscription information for all subscribers registered with the MMS service provider to whom the network belongs.

The present invention will be better understood with reference to exemplary scenarios of transmission and treatment of MMS messages by the MMS functionality spread in the MMS system 400. With reference being further made to FIG. 4, a first MMS UA “A” 402₈ transmits an MMS message 450 intended for a second MMS UA “B” 402₁₃. The MMS message 450 reaches the edge MMS Relay/Server 404 of the first stage of the MMS functionality, where it is stored. Upon receipt of the message 450, the server 404 issues an SMS notification 452, which is transmitted in order to alert the intended recipient, i.e. the second MMS UA “B” 402₁₃, of the existence of the message 450 to be retrieved from the MMS functionality of MMS system 400.

According to the present invention, the edge MMS Relay/Server may detect various criteria associated with the MMS message, and based on these criteria may relay the message to the proper MMS Relay Server of the MMS functionality for further handling.

In a first exemplary scenario of the preferred embodiment of the present invention, when the MMS Relay/Server 404 sends the SMS notification 452 to the recipient, it may also start a timer T1 420 for measuring the time value elapsed between the receipt of the MMS message 450 and the retrieval of the message from the server 404 by the intended recipient. When the timer T1 420 exceeds a predetermined value, such as for example five minutes, according to the invention, the MMS message 450 is forwarded from the MMS Relay/Server 404 to another MMS Relay/Server of the second stage of the MMS functionality. In the present case, the MMS message 450 is forwarded to the long term storage MMS Relay/Server 406, which is a server dedicated to long term storage of MMS messages. Upon receipt of the MMS message 450, the server 406 stores the message in a storage database 407. When the intended recipient of the MMS message desires to retrieve the message from the MMS functionality, it sends a request 454, such as for example an HTTP GET request message to the edge MMS Relay/Server 404. The service Logic 421 of the Server 404 detects that the message is no longer stored locally and redirects the HTTP request 454 to the server 406 where the MMS message 450 is now stored. The server 406 responds back with the MMS message 450, which is transmitted to the intended recipient MMS UA “B” 402₁₃.

In a variant of the first exemplary scenario of the preferred embodiment of the present invention, once the MMS Relay/Server 406 receives the MMS Message 450 for long-term storage in the database 407, it also start a timer T2 409 for measuring the storage duration of the message 450 into the database 407. When the storage duration exceeds a predetermined value, such as for example one week of time, the MMS message 450 is further transmitted to yet another MMS Relay/Server 414 intended for very long-term storage of MMS messages. Upon receipt of the MMS message 450, the server 414 stores the message into the very long-term storage database 415. When the recipient of the message 450 desires to retrieve the MMS message 450, he may proceed in a manner analogous to the previously described scenario, by sending the request 454, which is in the present case is forwarded up to the MMS Server 414 via the servers 404 and 406 to the server 414. The later responds back with the MMS message 450, which is sent to the intended recipient MMS UA “B” 402₁₃.

In a second exemplary scenario of the preferred embodiment of the present invention, upon receipt of the MMS message 450 from the MMS UA “A” 402₈, a service logic 421 of the MMS Relay/Server 404 first determines if the MMS message 450 relates to a prepaid subscriber, such as for example if either the originator or recipient or both may have a prepaid subscription. For the present example, it is assumed that the originator is a prepaid subscriber, and that charging is applied to message submission, not retrieval. If so, the MMS message 450 is forwarded to the MMS Relay/Server 410 of the second stage of the MMS functionality, which is responsible for the validation, storage and processing of prepaid MMS messages within the MMS system 400. The service logic 411 of the server 410 may perform the required analysis and/or processing of the prepaid MMS message 450. This action may involve communication with a prepaid server to verify availability of sufficient funds in the originating subscriber's account. If funds are unavailable, then the message is rejected, otherwise the transmission fee is charged to the subscriber's account, and processing continues as in the previous example.

In a third exemplary scenario of the preferred embodiment of the present invention, upon receipt of the MMS message 450 from the MMS UA “A” 402₈ at the MMS Relay/Server 404, the service logic 421 determines if the MMS message 450 is for immediate delivery to the recipient, or if alternatively the message 450 is intended for future delivery at a specified future time. If it is detected by the MMS service logic 421 that the MMS message 450 is intended for future delivery, the message 450 is forwarded to the MMS Relay/Server 408 of the second stage of the MMS functionality, where it is stored in a storage database 409. Once the delivery time is reached, the server 408 delivers the MMS message to the intended recipient, i.e. to the UA “B” 402₁₃, by sending an SMS notification as previously described.

In a forth exemplary scenario of the preferred embodiment of the present invention, upon receipt of the MMS message 450 from the MMS UA “A” 402₈ at the edge MMS server 404, the service logic 421 determines if the message 450 needs any transcoding and/or processing for being properly viewed on the particular terminal of the intended recipient. For this purpose, the service logic 421 may comprise a terminal capabilities database 423 where there are listed the terminal capabilities of the subscribers UAs 402ᵢ registered with the MMS functionality of the network 400. Using information from the database 423, upon receipt of the message 450, the service logic 421 first determines the terminal capabilities of the intended recipient of the message 450, which in the present case is MMS UA “B” 402₁₃. The service logic 421 determines if the received MMS message 450 can be viewed as is, without any transcoding/processing on the terminal of the MMS UA “B” 402₁₃. If not, the Server 404 forwards the MMS message 450 to the MMS Relay/Server 412 of the second stage of the MMS functionality, which is responsible for applying the appropriate transcoding/processing to the MMS message 450 so that it can be properly viewed on the terminal of the intended recipient. Following the transcoding/processing performed by the processing unit 413, the modified message 450′ is ready for delivery, as in the previous examples, by the MMS Relay/Server 412.

As it can be seen from the previous description of FIG. 4, according to the present invention, the MMS functionality of the network 400 is divided into multiple stages, wherein each such stage comprises one or more MMS Relay/Servers, each being dedicated to the handling of particular types or categories of MMS messages, such as for example but not limited to the ones previously exemplarily described: MMS messages that are stored for long periods of time before the retrieval, MMS messages that are intended for future delivery times, MMS messages that are originated and/or intended for prepaid subscribers, and MMS messages that need transcoding/processing in order to be viewed on specific types of terminals.

Reference is now made to FIG. 5, which is an exemplary high-level flowchart diagram of a method according to the preferred embodiment of the invention. The method of FIG. 5 starts with action 502 where the new MMS message is received at the edge MMS Relay/Server, i.e. at the first stage of the MMS functionality of the network. In action 504, the service logic of the Edge MMS Relay/Server detects whether or not the intended recipient of the MMS message is locally registered with the network and if not, the Edge server forwards the MMS message to the appropriate MMS Relay/Server with which the recipient is registered, so that the later can deliver the MMS message to the recipient, action 506. Otherwise, if the recipient of the message is locally registered with the network where the Edge MMS Relay/Server resides, in action 508 the service logic of the Edge MMS Relay/Server determines whether or not the MMS message is intended for future delivery, by checking if the message comprises a subsequent delivery time. If it is detected that the MMS message is intended for future delivery, the Edge MMS Relay/Server forwards the MMS message to the future delivery MMS Relay/Server of the second stage of the MMS functionality of the network, action 510, where the message is stored until the actual delivery to the MMS recipient. If it is rather detected in action 508 that the MMS message is for immediate delivery (negative outcome of action 508), then the method continues with action 512 where it is determined whether or not the sender and/or the receiver of the MMS message is a prepaid subscriber. If so, the MMS message is forwarded from the edge server to the prepaid MMS Relay/Server of the second stage of the MMS functionality, action 514, for treatment and processing as described in the above-mentioned second exemplary scenario of the present invention. Otherwise, if in action 512 it is rather detected that none of the sender and receiver of the MMS message is a prepaid subscriber (negative outcome of action 512), the method continues with action 516 where the service logic of the Edge MMS Relay/Server further detects, based on the terminal capabilities of the recipient of the MMS message, whether or not the MMS message needs further transcoding/processing in order to be properly viewed on the recipient's terminal. In case the message needs further processing/transcoding, the edge MMS Relay/Server forwards the MMS message to the transcoding MMS Relay/Server of the second stage of the MMS functionality of the network, action 518, so that the message gets adapted in a format that may be properly viewed on the recipient's terminal. In the opposite case, wherein in action 516 it is rather detected that the MMS message does not need any further transcoding/processing, the method continues with action 520 where an SMS notification is sent out for the intended recipient to inform about the existence of the MMS message ready to be retrieved. It is to be noted that action 520 may also be performed subsequent to action 518, once the transcoding MMS Relay/Server adapts the MMS message for viewing on the specified terminal. Alternatively, the Edge MMS Relay/Server may be also configured to send out the SMS notification for the MMS recipient before its service logic performs any of the actions 504-518. In any case, following action 520 as shown in the exemplary FIG. 5, the Edge MMS the Relay/Server may also start a timer to monitor the duration before the message is retrieved by the recipient from the server, action 522, and in action 524 may detect when the timer exceeds a predetermined value, such as for example five minutes. When the timer exceeds the predetermined value, the Edge MMS Relay/Server performs action 526 wherein the MMS message is forwarded to the long-term storage MMS Relay/Server of the second stage of the MMS functionality of the network, where it is stored until it is retrieved by the recipient. Although not explicitly shown in FIG. 5, following action 526 other steps analogous to the starting of a timer of action 522 and the time duration detection for the retrieval of the message like the one described in action 524 may further be performed by the long-term storage MMS server. These actions may further result in yet another transmission of the MMS message to an MMS server of a third stage of the MMS functionality, such as for example to a very long-term storage MMS server as described beforehand with relation to FIG. 4. Finally, in action 528, the MMS message is delivered to the intended recipient upon request of the later, when the request is made before the timer reaches the predetermined value of time.

As it can be seen particularly with reference to FIG. 5, according to the present invention various criteria are determined with respect to either the type of the MMS message received at the edge MMS server or with respect to the time taken for delivery of the message to the intended to recipient. Then based on such criteria, the MMS message is forwarded to, handled, and stored by a particular one of the MMS Relay/Servers of the MMS functionality that is spread over the MMS system 400. With reference to FIG. 5, the actions associated with the detection of such criteria that trigger the handling of the MMS message are shown in dotted lines 540.

Therefore, the present invention allows for more flexibility in the implementation of an MMS functionality in a given telecommunications network and eliminates the possible bottleneck created by the use of only one MMS Relay/Server of that network. By using MMS Relay/Servers which are each dedicated to the treatment of one given type of MMS messages, the present invention accelerates the treatment of such messages, and make easier the scaling of the MMS functionality to cope with the variation of the MMS traffic, both on the short term and long term.

Based upon the foregoing, it should now be apparent to those of ordinary skills in the art that the present invention provides an advantageous solution for MMS messaging based on the nature of the message originator and/or recipient's subscriptions, or of the content of the message, for determining the most appropriate node for handling such MMS message. Although the system and method of the present invention have been described in particular reference to certain exemplary scenarios, it should be realized upon reference hereto that the innovative teachings contained herein are not necessarily limited thereto and that the invention may be implemented as described hereinbefore, or as parts of the previous description. For example, not all the MMS Relay/Servers described herein may be implemented in solely one given network. Likewise, a variable number of stages of the MMS functionality may also be implemented depending on the network operator's specific needs. Finally, although the Edge MMS Relay/Server has been described in the above exemplary description as receiving MMS messages directly from the community of UAs, it is understood that the Edge MMS/Relay server may as well receive the MMS messages via other MMS Relay/Servers, or other routing nodes. Likewise, other MMS Relay/Servers then the Edge server may also perform functions that were described hereinabove in relation to the Edge MMS Relay/Server. Thus, it will be understood that the above-mentioned terminology referring to the Edge MMS Relay/Server should be interpreted broadly in the following claims as an MMS Relay/Server that is not necessarily the closest server/router to the UAs, or part of the 1^{st} stage of MMS Relay/Servers, but rather any server/router that applies MMS message redirecting/forwarding based on the type or content of the MMS messages, which may be part of any given stage of MMS Relay/Servers as shown in FIG. 5.

It is to be further noted, that the present invention may be implemented advantageously with any applicable radio telecommunications standard, including but being not limited to (GSM/GPRS, UMTS, CDMA, CDMA 2000). It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth herein below.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for handling a Multimedia Messaging Service (MMS) message in an MMS system, the method comprising the steps of:
a. receiving an incoming MMS message at an Edge MMS Relay/Server of the MMS system;
b. determining in the Edge MMS Relay/Server one or more criteria related to the incoming MMS message; and
c. responsive to the determination of the one or more criteria related to the MMS message, forwarding the MMS message from the Edge MMS Relay/Server to another MMS Relay/Server of a second stage of the MMS system;
wherein the other MMS Relay/Server is connected to the Edge MMS Relay/Server and is responsible for handling MMS messages that satisfy the one or more criteria.

2. The method claimed in claim 1, further comprising the step of:
d. delivering the MMS message to an MMS recipient from the other MMS Relay/Server.

3. The method claimed in claim 1, wherein the MMS message originates from a first MMS User Agent (UA) and is destined to a second MMS UA.

4. The method claimed in claim 1, wherein step b. comprises the step of:
b.1. determining whether or not the MMS message is intended for future delivery;
wherein if the MMS message is intended for future delivery, the Edge MMS Relay/Server forwards the MMS message to the other MMS Relay/Server, which is responsible for the handling of MMS messages that have a future delivery time.

5. The method claimed in claim 4, further comprising the step of:
d. delivering the MMS message from the other MMS Relay/Server to an MMS recipient when the delivery time of the MMS message is reached.

6. The method claimed in claim 1, wherein step b. comprises the step of:
b.1. determining whether or not the MMS message originates or is destined to an MMS User Agent (UA) of prepaid subscriber;
wherein if the MMS message originates or is destined to the MMS UA of a prepaid subscriber, the Edge MMS Relay/Server forwards the MMS message to the other MMS Relay/Server, which is responsible for the handling of MMS messages related to prepaid subscribers.

7. The method claimed in claim 1, wherein step b. comprises the step of:
b.1. determining whether or not the MMS message is retrieved by an MMS recipient from the Edge MMS Relay/Server within a predetermined period of time;
wherein if the MMS message originates or is not retrieved by the MMS recipient from the Edge MMS Relay/Server within the predetermined period of time, the Edge MMS Relay/Server forwards the MMS message to the other MMS Relay/Server, which is responsible for the handling of MMS messages stored by the MMS system for periods of time exceeding the predetermined period of time.

8. The method claimed in claim 1, wherein step b. comprises the step of:
b.1. determining whether or not the MMS message needs further processing or transcoding in order to be properly displayed on an MMS User Agent (UA) terminal of the recipient;
wherein if the MMS message needs further processing or transcoding in order to be properly displayed on the MMS UA terminal of the recipient, the Edge MMS Relay/Server forwards the MMS message to the other MMS Relay/Server, which is responsible for the processing and transcoding of MMS messages that are to be adapted for proper display on a given type of UA terminal.

9. The method claimed in claim 8, further comprising the step of:
processing the MMS message in the MMS Relay/Server responsible for the processing and transcoding of MMS messages in order to adapt the MMS message for proper display on the MMS UA terminal of the recipient.

10. The method claimed in claim 1, wherein the other MMS Relay/Server is connected to the Edge MMS Relay/Server via an MM4 interface.

11. An Edge Multimedia Messaging Service (MMS) Relay/Server for use in an MMS system, the Edge MMS Relay/Server comprising:
service logic acting to determine one or more criteria related to an incoming MMS message, and responsive to the determination of the one or more criteria, further acting to forward the MMS message from the Edge MMS Relay/Server to another MMS Relay/Server of a second stage of the MMS system;
wherein the Edge MMS Relay/Server is connected to the other MMS Relay/Server which is responsible for handling MMS messages that satisfy the one or more criteria.

12. The Edge MMS Relay/Server claimed in claim 11, wherein the incoming MMS message received by the Edge MMS Relay/Server originates from a first MMS User Agent (UA) and is destined to a second MMS UA.

13. The Edge MMS Relay/Server claimed in claim 11, wherein the service logic determines whether or not the MMS message is intended for future delivery;
wherein if the MMS message is intended for future delivery, the Edge MMS Relay/Server forwards the MMS message to the other MMS Relay/Server, which is responsible for the handling of MMS messages that have a future delivery time.

14. The Edge MMS Relay/Server claimed in claim 11, wherein the service logic determines whether or not the MMS message originates or is destined to an MMS User Agent (UA) of a prepaid subscriber;
wherein if the MMS message originates or is destined to an MMS UA of a prepaid subscriber, the Edge MMS Relay/Server forwards the MMS message to the other MMS Relay/Server, which is responsible for the handling of MMS messages related to prepaid subscribers.

15. The Edge MMS Relay/Server claimed in claim 11, wherein the service logic determines whether or not the MMS message is retrieved by an MMS recipient from the Edge MMS Relay/Server within a predetermined period of time;
wherein if the MMS message is not retrieved by the MMS recipient from the Edge MMS Relay/Server within the predetermined period of time, the Edge MMS Relay/Server forwards the MMS message to the other MMS Relay/Server, which is responsible for the handling of MMS messages stored for periods of time exceeding the predetermined period of time.

16. The Edge MMS Relay/Server claimed in claim 11, wherein the service logic determines whether or not the MMS message needs further processing or transcoding in order to be properly displayed on the MMS User Agent (UA) terminal of the recipient;
wherein if the MMS message needs further processing or transcoding in order to be properly displayed on the MMS UA terminal of the recipient, the Edge MMS Relay/Server forwards the MMS message to the other MMS Relay/Server, which is responsible for the processing and transcoding of MMS messages that are to be adapted for proper display on a given type of UA terminal.

17. The method claimed in claim 11, wherein the other MMS Relay/Server is connected to the Edge MMS Relay/Server via an MM4 interface.

18. A Multimedia Messaging Service (MMS) system comprising:
a first stage of MMS Relay/Servers containing an Edge MMS Relay/Server receiving incoming MMS messages from MMS User Agents (UAs); and
a second stage of MMS Relay/Servers containing a plurality of MMS Relay/Servers, each MMS Relay/Server from the plurality of MMS Relay/Servers being responsible for the handling of a certain type of MMS messages;
wherein the Edge MMS Relay/Server determines one or more criteria related to an incoming MMS message, and responsive to the determination of the one or more criteria related to the MMS message, forwards the MMS message to one MMS Relay/Server of the plurality of MMS Relay/Servers.

19. The MMS system claimed in claim 18, wherein the one MMS Relay/Server further acts to deliver the MMS message to an MMS recipient.

20. The MMS system claimed in claim 18, wherein the MMS message originates from a first MMS UA and is destined to a second MMS UA.

21. The MMS system claimed in claim 18, wherein the Edge MMS Relay/Server determines whether or not the MMS message is intended for future delivery;
wherein if the MMS message is intended for future delivery, the Edge MMS Relay/Server forwards the MMS message to the other MMS Relay/Server, which is responsible for the handling of MMS messages that have a future delivery time.

22. The MMS system claimed in claim 21, wherein the one MMS Relay/Server further delivers the MMS message to an MMS recipient when the delivery time of the MMS message is reached.

23. The MMS system claimed in claim 18, wherein the Edge Relay/Server determines whether or not the MMS message originates or is destined to an MMS UA of a prepaid subscriber;
wherein if the MMS message originates or is destined to an MMS UA of a prepaid subscriber, the Edge MMS Relay/Server forwards the MMS message to the one other MMS Relay/Server, which is responsible for the handling of MMS messages related to prepaid subscribers.

24. The MMS system claimed in claim 18, wherein the Edge MMS Relay/Server determines whether or not the MMS message is retrieved by an MMS recipient from the Edge MMS Relay/Server within a predetermined period of time;
wherein if the MMS message originates or is not retrieved by the MMS recipient from the Edge MMS Relay/Server within the predetermined period of time, the Edge MMS Relay/Server forwards the MMS message to the one MMS Relay/Server, which is responsible for the handling of MMS messages stored for periods of time exceeding the predetermined period of time.

25. The MMS system claimed in claim 18, wherein the Edge MMS Relay/Sever determines whether or not the MMS message needs further processing or transcoding in order to be properly displayed on an MMS UA terminal of the recipient;
wherein if the MMS message needs further processing or transcoding in order to be properly displayed on the MMS UA terminal of the recipient, the Edge MMS Relay/Server forwards the MMS message to the one MMS Relay/Server, which is responsible for the processing and transcoding of MMS messages that are to be adapted for proper display on a given type of UA terminal.

26. The MMS system claimed in claim 25, wherein the one other MMS Relay/Server processes the MMS message in order to adapt the MMS message for proper display on the MMS UA terminal of the recipient.

27. The MMS system claimed in claim 18, wherein the one other MMS Relay/Server is connected to the Edge MMS Relay/Server via an MM4 interface.
